(19) United States
(12) Patent Application Publication
(10) Pub. No.: US 2017/0046732 A1
(43) Pub. Date: Feb. 16, 2017

(54) TRAINING A MACHINE TO DYNAMICALLY DETERMINE AND COMMUNICATE CUSTOMIZED, PRODUCT-DEPENDENT PROMOTIONS WITH NO OR LIMITED HISTORICAL DATA OVER A NETWORK

(71) Applicant: International Business Machines Corporation, Armonk, NY (US)

(72) Inventors: Adam N. Elmachtoub, New York, NY (US); Markus R. Ettl, Ossining, NY (US); Sechan Oh, Stanford, CA (US); Marek Petrik, Croton on Hudson, NY (US); Rajesh K. Ravi, Yorktown Heights, NY (US)

(21) Appl. No.: 14/826,914

(22) Filed: Aug. 14, 2015

(51) Int. Cl. G06Q 30/02; G06N 99/00

(52) U.S. Cl. CPC G06Q 30/0243; G06Q 30/0256; G06N 99/005

(57) ABSTRACT

Training a machine to learn to offer personalized promotions over a network is provided. A promotion optimization engine may take logit models and their confidence measures, and compute the acceptance probability of each promotion based on the customer and product features. A target promotion may be determined based on an objective function, which jointly considers the acceptance probability and the logit model's confidence level. A cognitive engine receives a user response to the promotion and based on the user response, updates parameters of the logit model and confidence level associated with the logit model. In one aspect, a signal to offer the promotion is transmitted via a communication channel to a user's device, wherein the signal causes the user's device to automatically connect to one or more of the processors to receive the promotion, e.g., when the user's device is online.

### FIELD

The present application relates generally to a computer to computer communications, computer applications, and more particularly to training a machine to dynamically determine and offer customized, product-dependent promotions with no or limited historical data.

### BACKGROUND

Customer-based personalization may not be enough for delivering effective product promotions. Consider for example, a ticket for a journey from an originating place to a destination place. There may be numerous possible journey-customer combinations. The present disclosure addresses, in one aspect, training a machine to effectively determine a promotion that is optimal for complex products to heterogeneous customers. In another aspect, the present disclosure addresses effectively communicating the promotion which may be time sensitive over a network to a user.

### BRIEF SUMMARY

A system and method for training a machine to learn to offer personalized promotions over a network may be provided. A system may comprise a promotion optimization engine operable to execute on one or more of processors. The promotion optimization engine may be further operable to receive a first set of features associated with a user that entered a search query for a product. The promotion optimization engine may be further operable to receive a second set of features associated with the product. The promotion optimization engine may be further operable to, based on a logit model and the first set of features and the second set of features, predict a probability that the user accepts a promotion from a set of promotion options available to anonymous users. The promotion optimization engine, in one aspect, predicts the probability for each of the promotion options in the set of promotion options. The promotion optimization engine may be further operable to determine a target promotion from the set of promotion options based on an objective function that jointly considers the probability and a confidence level associated with the logit model. A cognitive engine may be operable to execute on one or more of the processors and further operable to receive a user response to the target promotion. Based on the user response, the cognitive engine may be further operable to update parameters of the logit model and the confidence level.

A method of training a machine to learn to offer personalized promotions over a network, in one aspect, may comprise receiving a first set of features associated with a user that entered a search query for a product. The method may also include receiving a second set of features associated with the product. The method may further include, based on a logit model and the first set of features and the second set of features, predicting a probability that the user accepts a promotion from a set of promotion options available to anonymous users for each of the promotion options in the set of promotion options. The method may further include determining a target promotion from the set of promotion options based on an objective function that jointly considers the probability and a confidence level associated with the logit model. The method may also include transmitting the promotion to a user's device. The method may further include receiving a user response to the target promotion. The method may further include, based on the user response, updating parameters of the logit model and the confidence level. In one aspect, the transmitting of the promotion to the user's device may include transmitting a signal to offer the promotion via a communication channel to a user's device, wherein the signal causes the user's device to automatically connect to one or more of the processors to receive the promotion.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating components of a system including a machine that is dynamically trained to learn to determine personalized, product-dependent promotions with no or limited historical data in one embodiment of the present disclosure.

FIG. 2 is a flow diagram illustrating a method of training a machine to offer personalized, product-dependent promotion in one embodiment of the present disclosure.

FIG. 3 is an example user interface for an example product in one embodiment of the present disclosure.

FIG. 4 illustrates a schematic of an example computer or processing system that may implement a training system in one embodiment of the present disclosure.

### DETAILED DESCRIPTION

A computer-implemented service or system, and methodologies thereof, are presented that generate and notify a user of customized product-dependent promotion offers in one embodiment of the present disclosure. In one aspect, the customized product dependent offers may be provided over a communication network or channel to a user's device (e.g., mobile device). An alert may be sent to a user device notifying the user device that a promotion or offer is available, which may automatically invoke or activate an application or the like on the user's device to connect to a system source that is offering the promotion, for example, when the user's device comes online. In this way, time sensitive customized product dependent offers that may change dynamically based on real-time dynamic factors may be communicated to a user in a timely manner. Yet in another aspect, a computer-implemented system of the present disclosure in one embodiment is a machine learning system, in which a machine is trained and continues to learn based on dynamic user responses to produce an optimal promotion offers that are determined based on specific product features and user features.

The computer-implemented system, in one aspect, may determine how to deliver the right promotion for complex products to heterogeneous customers. For instance, given all the information about customers, the computer-implemented system may determine how to deliver the right promotion, e.g. without having historical data on promotion. For example, in one aspect, a customer-based personalization may not be enough for delivering effective product promotions. Consider, e.g., airline promotions. Depending on the journey, different promotions may be more effective even for the same customer. For example, when the journey includes a long connection time, the most effective promotion may be a free access to business lounge, whereas when the journey only has one short-distance direct flight, the most effective promotion may be a price discount. The computer-implemented system, in one aspect, may address how to deliver the right journey and customer-dependent promotion, e.g., in the presence of many, e.g., practically billions, of possible journey-customer combinations. For example, there could be about 1.6 billion itinerary options for an origin-destination round trip journey, and customers can be described by over 100 data features (e.g., miles, sales transaction, search history, tier level, and others).

The computer-implemented system in one embodiment provides a personalized promotion to a customer or user, with limited to no historical data by applying a multi-armed bandit model to personalized promotions. The computer-implemented system in one embodiment need not require historical transactions and may offer response data at the product level. The method in the present disclosure in one embodiment can start without historical data and may focus on customer-product interaction, for example, using customer preferences to improve personalized recommendations.

The computer-implemented system in one embodiment may take direct input on the product of interest from the customers, and also address dynamic learning and optimized learning. The computer-implemented system in one embodiment may estimate the success probability of a certain offer by considering features (e.g., including sub-product features) of the product jointly with customer features. The computer-implemented system in one embodiment may consider “no offer” option. In the multi-armed bandit in the present disclosure, rewards of bandits explicitly depend on the context (e.g., product and customer features) and may distinguish customer features and product features.

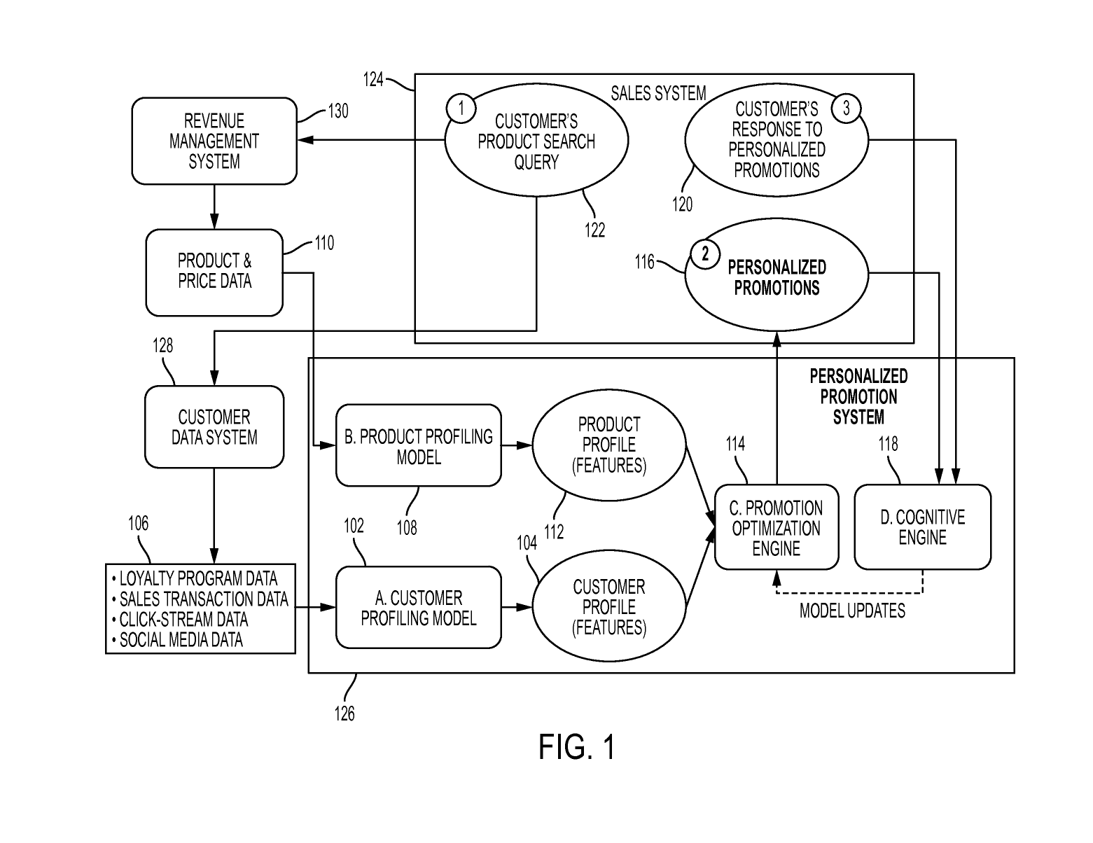

FIG. 1 is a diagram illustrating components of a system including a machine that is dynamically trained to learn to determine product-dependent promotions with no or limited historical data in one embodiment of the present disclosure. A customer profiling model 102 takes customer identifier (ID) and generates a set of customer features 104, also referred to as a customer profile, from historical data (e.g., purchase history data, loyalty program data, click-stream data, social media data) 106.

A product profiling model 108 takes into account the product the customer is looking for 110 and constructs a set of features of the product 112, also referred to as a product profile. Examples of such features may include but are not limited to, price, loyalty points to be earned, and other specification of the product.

A promotion optimization engine 114 estimates the probability that the customer accepts each promotion from a set of available promotion options and chooses a promotion determined to be the best promotion 116, e.g., also referred to as a target promotion. In one embodiment, the set of available promotion options includes the public offer that is available to anonymous customers. In one embodiment, the probability estimation model is a promotion specific logit model that takes customer features and product features. In one embodiment, the objective function of the optimization problem is the addition of the expected rewards and standard deviation of the rewards. The expected reward is the multiplication of (price of the product−cost of the promotion) and the acceptance probability. The standard deviation of reward is based on the confidence level of the logit model.

A cognitive engine 118 observes the user's response to an offered promotion 120 and updates the model parameters of the promotion optimization engine 114, e.g., updates the parameters of the logit model and its confidence level.

For example, responsive to receiving a query associated with a product (e.g., travel ticket for a journey), the personalized promotion system 124 may generate and provide a personalized offer, which can be the same as the public offer, e.g., based on the recommendation provided by a multi-armed bandit model that takes as an input the data corresponding to a customer 104 and the product (e.g., journey) 112. If the offer is accepted by the customer, the seller receives a payment from the customer, and provides the promised products and services to the customer. The customer acceptance decision and the snapshot of the customer features and product features are recorded. Cognitive engine 118 updates the parameters of the logit model and its confidence level periodically, e.g., after every response or every hour, using newly recorded customer responses.

The promotion optimization engine 114 may perform the following analytics in one embodiment of the present disclosure to generate a promotional offer. In one embodiment, the data for customer m, xₘ, may include basic profile information, historical transactions (e.g., miles redemption/awards) and purchases (e.g., ticket purchases), and behavioral information (e.g., click-stream data, last login, number of logins within a time period, e.g., 24 hours). The data for a product may include price, loyalty points to be earned and other key specification of the product. Taking journey as a product example, the data for journey j, yⱼ, may include origin, destination, distance, number of passengers, time-to-departure, itinerary (e.g., dates, time, day of week, number of stops, lay-over time), miles to be earned, and ticket price (denoted by pⱼ).

For a given promotion i, the reward of acceptance may include Rᵢⱼ=pⱼ−cᵢpⱼ−dᵢ, where cᵢ and dᵢ denote the variable and fixed cost of promotion i.

For a given promotion i, customer m, and journey j, the probability that a customer accepts the promotion is

$$\frac{1}{1 + exp ( - {β}_{i} {x}_{m} - {γ}_{i} {y}_{j} )} .$$

This corresponds to a logit model. The promotion i specific vectors βᵢ and γᵢ are unknown and estimated using logistic regression with the data observed so far. Regularization is appropriate since this is high-dimensional data (>100 features).

For a given promotion i, the system of the present disclosure computes a standard deviation term based on the data observed so far, which is denoted by σᵢ.

For a given customer m and journey j, the system of the present disclosure offers the promotion that maximizes

$${R}_{ij} ( \frac{1}{1 + exp ( - {β}_{i} {x}_{m} - {γ}_{i} {y}_{j} )} + {σ}_{i} ) .$$

Based on the customer's response to the promotion, the system of the present disclosure re-estimates βᵢ, γᵢ and σᵢ.

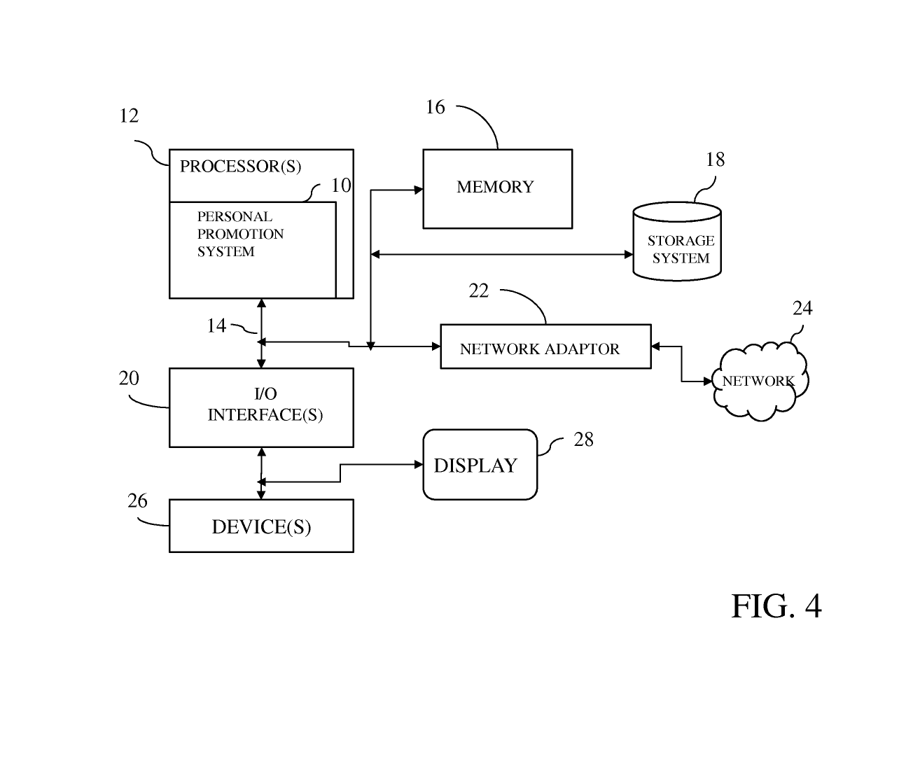

The customer profiling model 102, product profiling model 108, promotion optimization engine 114 and cognitive engine 118 may be implemented as computer components that execute on one or more processors of a computer. An example configuration of such a computer is shown and described with reference to FIG. 4 below. The product profile 112 and customer profile 104 may be stored in one or more storage devices, e.g., coupled to the one or more processors.

A sales system 122, for example, may allow a user or customer to submit a query associated with a product. A customer data system 128 may extract data 106 associated with the customer based on the customer's product search query 122. A system such as a revenue management system 130 may extract product and price data 110 about the product that is a subject of the query, based on the customer's product search query 122. An offer generated by the personalized promotion system 126 may be presented by the sales system 124 to the customer, for example, as shown at 116.

The sales system 122 may include computer-implemented components, for example, computer-executable processing components and storage media for executing various functionalities of a sales system that allows a user to search for a product (or service) via a user interface and present a generated offer to the user. A revenue management system 130 may be a computer-implemented component that executes on one or more processors and extracts product and price data 130 from a database of product information (not shown) based on a customer's product search query 122. A customer data system 128 may be a computer-implemented component that executes on one or more processors, and maintain customer data for example stored in a database of customer information (not shown). The customer data system 128 may retrieve or extract customer data 106 for input to the personalized promotion system 126.

In one embodiment, an application may be provided on a user's device, e.g., which receives a product dependent promotion alert related to the user's product search query 124, when the product dependent promotion becomes available, for example, from the personalized promotion system 126, based on dynamic real-time data. The product dependent promotion alert may cause the application to automatically connect to a product offeror's system, for example, a web site via using the web site's uniform resource locator (URL) of the product offeror. Once in the web site, the user may view more details of the promotion offer.

In one embodiment, the application provided on the user's device may include the functionalities of a sales system 124, which for example, receives customer's product search query 122, for example, via a user interface, displays or presents the personalized promotions 116 on the user's device (this may be done by the application automatically connecting to a product offeror's web site), for example, when the user's device comes online, and transmits the customer's response to personalized promotions responsive to receiving the customer's response via the user interface.

In one embodiment, the personalized promotion system may transmit a promotion alert to a user's wireless device over a wireless communication channel. The alert activates the application to display the product promotion offer to the user, e.g., by automatically connecting to a website of the product offeror when the device on which the application is deployed comes online. The device on which the application is deployed may be the same user's wireless device that received the promotion alert, or another device or computer that the user's wireless device connects to.

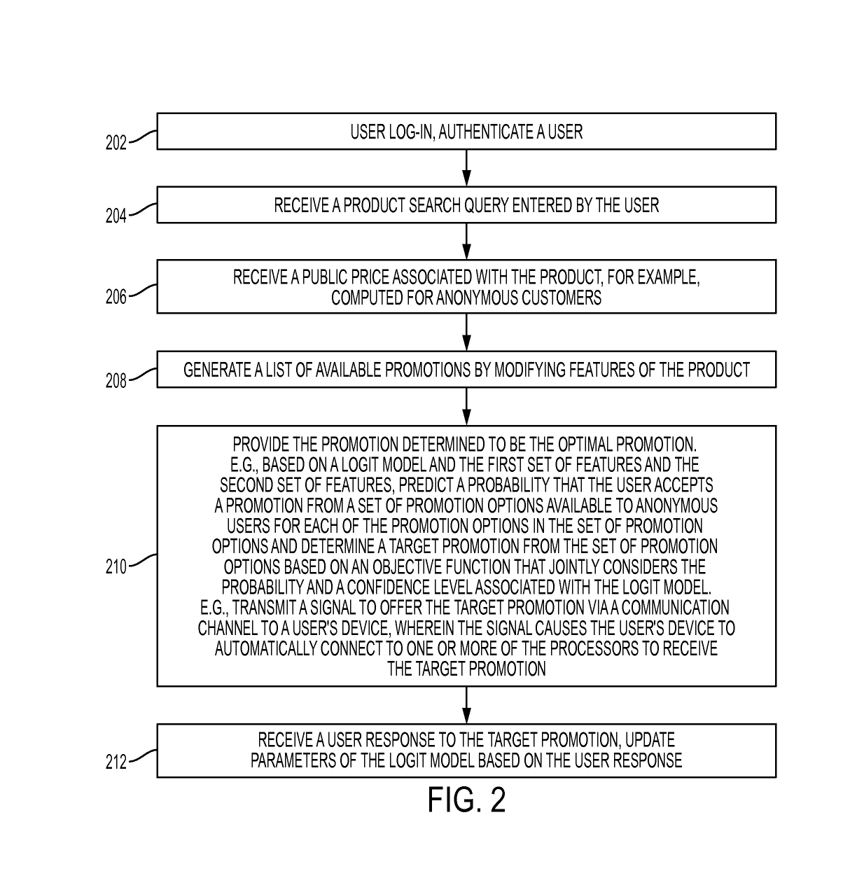

FIG. 2 is a flow diagram illustrating a method of training a machine to offer personalized, product-dependent promotion in one embodiment of the present disclosure. At 202, a user may be authenticated into a promotion offering system or application. For example, a user may login. At 204, a product search query may be received. For instance, the user enters a search query associated with a product. A pricing or revenue management system, based on the search query, may generate or compute a public price. Public price is a price that is offered to anonymous users, e.g., a price that may have been computed without considering user specific features.

Based on the search query and a database of user information, a set of user features (also referred to as a first set of features associated with a user) may be generated. Based on the search query and a database of product information, a set of product features (also referred to as a second set of features associated with a product) may be generated.

At 206, a public price computed, e.g., by a pricing or revenue management system may be received.

At 208, a list of available offers may be generated by modifying features of the product (e.g., adding ancillary service or product discount price). For example, the promotion optimization engine shown in FIG. 1 at 114 may generate the list of available offers.

At 210, the best promotion offer is provided to the user. The best promotion offer, e.g., may be determined by a logit model described above. For example, a logit model is generated and calibrated by determining its parameter values based on observed customer responses to the promotion and corresponding snapshots of the customer and product features. Then, the probability that a user accepts a promotion is computed by the logit model and available data (also referred to as user features or first set of features) associated with the user (e.g., a customer) and product specific features of the product (also referred to as product features or second set of features) in the search query. In one aspect, a “no offer” option is also included and considered in determining the best promotion offer. An objective function based on the estimated acceptance probability and its confidence level is solved to determine the best promotion offer. The best promotion offer may be provided to a user's device that is located remotely via a communication network.

At 212, user response is received and the offer recommendation engine, also referred to as a promotion optimization engine, is updated based on the user response. For example, the parameter values of a logit model is updated based on the snapshot of the features of the user and the product, and user's response that user accepted or not accepted the promotion offer, e.g., reconstructing the logit model with additional data points In this way, the machine or the promotion optimization engine is trained to dynamically learn the promotion offers that are considered to be optimal, e.g., produce optimal reward to the seller.

In one embodiment, a logit model of a promotion is a probability estimation function that takes customer and product features as inputs, and generates acceptance probability of the promotion as an output. The construction of the logit models includes the task of computing the parameters of the logit model (e.g., beta and gamma described above), which can be done via logistic regression using the data on observed customer responses to the promotion and the snapshots of customer and product features when they were offered the promotion. The system and/or of the present disclosure (e.g., the cognitive engine shown in FIG. 1 at 118) may observe one or more responses to a promotion, and update the logit model. A logit model is constructed for a promotion, for example, for each of possible promotions.

The system and/or method of the present disclosure (e.g., the promotion optimization engine shown in FIG. 1 at 114) may take the logit models and their confidence measures from the cognitive engine, and compute the acceptance probability of each promotion based on the customer and product features. In one embodiment, the best promotion depends on an objective function, e.g., described above, which jointly considers the acceptance probability and its confidence level. By doing so, the system and/or method of the present disclosure in one embodiment ensure that the system and/or method can make more observations for insufficiently learned promotion, and for example, the cognitive engine can produce confident (robust) logit models moving forward.

The methodology of the present disclosure may be applied in travel industry. New Distribution Capability (NDC) is a travel industry-supported program launched by IATA for the development and market adoption of a new, extended markup language (XML)-based data transmission standard. NDC shopping schemas enable airlines to distribute their full product offers and to merchandize their baggage, seat choices and ancillary services, using rich content, in an anonymous or personalized manner. The methodology in the present disclosure may determine the best personalized offerings and prices using real-time data about customers and journey, e.g., using data that may include person context (e.g., historical ticket purchase data, loyalty program data, click-stream data, social media data, and/or others) and journey context (e.g., itinerary, time-to-departure, departure day of week, number of passengers, and/or others). The methodology of the present disclosure in one embodiment can start without historical offer response data, and can learn from customer responses, and can dynamically adapt to changing response behaviors.

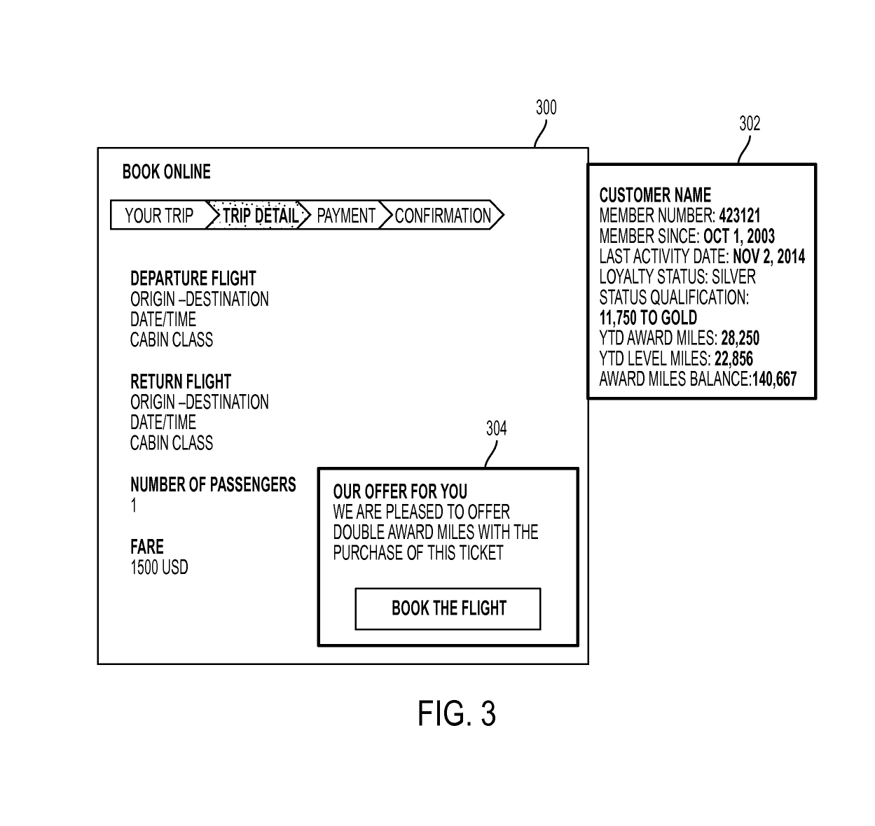

In one embodiment, a user may enter a search query via a product offeror's website. A browser user interface displayed by the product offeror's URL may present a user interface that allows a user to query for a product. The search query then may be received by a system of the present disclosure. The system of the present disclosure may determine a promotion or promotion offer. A promotion may include an additional item or perk provided with a product to increase the likelihood of a user purchasing the product. A promotion offer determined by the system of the present disclosure may be presented on the user interface. FIG. 3 is an example user interface 300 for an example product in one embodiment of the present disclosure. In this example, the product that is searched is a ticket for a journey. Based on the product features and user features (e.g., shown at 302), the system of the present disclosure may determine a personalized offer (e.g., shown at 304) to the user. Examples of possible personalized offers may include but are not limited to percentage price discount (e.g., 5% price discount), discounted business class upgrade, various percentage levels of bonus qualifying miles (e.g., 25%, 50%), various percentage levels of qualifying miles (e.g., 25%, 50%, 100%), free pass to business lounges, free chauffeur service.

FIG. 4 illustrates a schematic of an example computer or processing system that may implement a training system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A system for training a machine to learn to offer personalized promotions over a network, comprising:
one or more processors;
a promotion optimization engine operable to execute on one or more of the processors, the promotion optimization engine further operable to receive a first set of features associated with a user that entered a search query for a product,
the promotion optimization engine further operable to receive a second set of features associated with the product,
the promotion optimization engine further operable to, based on a logit model and the first set of features and the second set of features, predict a probability that the user accepts a promotion from a set of promotion options available to anonymous users for each of the promotion options in the set of promotion options,
the promotion optimization engine further operable to determine a target promotion from the set of promotion options based on an objective function that jointly considers the probability and a confidence level associated with the logit model; and
a cognitive engine operable to execute on one or more of the processors and further operable to receive a user response to the target promotion, and based on the user response, update parameters of the logit model and the confidence level.

2. The system of claim 1, wherein the one or more of the processors is operable to construct the logit model comprising a probability estimation function that takes the first set of features and the second set of features and generates an acceptance probability of the promotion, the one or more processors operable to construct the logit model by determining the parameters of the logit model via logistic regression using data associated with observed responses to the promotion of users and snapshots of user features of the users and product features of one or more products for which the promotion was offered.

3. The system of claim 1, further comprising a customer profiling model operable to execute on one or more of the processors, and further operable to generate the first set of features associated with the user.

4. The system of claim 1, wherein the first set of features comprises purchase history data, loyalty program data, click-stream data, and social media data.

5. The system of claim 1, further comprising a product profiling model operable to execute on one or more of the processors, and further operable to generate the second set of features associated with the product.

6. The system of claim 1, wherein the second set of features comprises price, loyalty points and one or more specifications associated with the product.

7. The system of claim 1, wherein the promotion optimization engine determines a promotion by maximizing the optimization function comprising an addition of expected rewards and standard deviation of the rewards, the expected rewards comprising a multiplication of a price of the product minus a cost of the promotion and an acceptance probability, and the standard deviation of the rewards based on the confidence level of the logit model.

8. The system of claim 1, wherein the promotion optimization engine is further operable to transmit a signal to offer of the promotion via a communication channel to a user's device, wherein the signal automatically causes the user's device to automatically connect to one or more of the processors executing the cognitive engine.

9. A method of training a machine to learn to offer personalized promotions over a network, the method executed on one or more processors, comprising:
receiving a first set of features associated with a user that entered a search query for a product;
receiving a second set of features associated with the product;
based on a logit model and the first set of features and the second set of features, predicting a probability that the user accepts a promotion from a set of promotion options available to anonymous users for each of the promotion options in the set of promotion options;
determining a target promotion from the set of promotion options based on an objective function that jointly considers the probability and a confidence level associated with the logit model; and
transmitting the promotion to a user's device;
receiving a user response to the target promotion; and
based on the user response, updating parameters of the logit model and the confidence level.

10. The method of claim 9, wherein the transmitting further comprises transmitting a signal to offer the promotion via a communication channel to a user's device, wherein the signal automatically causes the user's device to automatically connect to one or more of the processors to receive the promotion.

11. The method of claim 9, further comprising generating the first set of features associated with the user and the second set of features associated with the product.

12. The method of claim 9, wherein the first set of features comprises purchase history data, loyalty program data, click-stream data, and social media data.

13. The method of claim 9, wherein the second set of features comprises price, loyalty points and one or more specifications associated with the product.

14. The method of claim 9, wherein the promotion is determined by maximizing the optimization function comprising an addition of expected rewards and standard deviation of the rewards, the expected rewards comprising a multiplication of a price of the product minus a cost of the promotion and an acceptance probability, and the standard deviation of the rewards based on the confidence level of the logit model.

15. A computer readable storage medium storing a program of instructions executable by a machine to perform a method of training a machine to learn to offer personalized promotions over a network, the method executed on one or more processors, the method comprising:
receiving a first set of features associated with a user that entered a search query for a product;
receiving a second set of features associated with the product;
based on a logit model and the first set of features and the second set of features, predicting a probability that the user accepts a promotion from a set of promotion options available to anonymous users for each of the promotion options in the set of promotion options;
determining a target promotion from the set of promotion options based on an objective function that jointly considers the probability and a confidence level associated with the logit model; and
transmitting the promotion to a user's device;
receiving a user response to the target promotion; and
based on the user response, updating parameters of the logit model and the confidence level.

16. The computer readable storage medium of claim 15, wherein the transmitting further comprises transmitting a signal to offer the promotion via a communication channel to a user's device, wherein the signal automatically causes the user's device to automatically connect to one or more of the processors to receive the promotion.

17. The computer readable storage medium of claim 15, further comprising generating the first set of features associated with the user, wherein the first set of features comprises purchase history data, loyalty program data, click-stream data, and social media data.

18. The computer readable storage medium of claim 15, further comprising generating the second set of features associated with the product, wherein the second set of features comprises price, loyalty points and one or more specifications associated with the product.

19. The computer readable storage medium of claim 15, wherein the promotion is determined by maximizing the optimization function comprising an addition of expected rewards and standard deviation of the rewards, the expected rewards comprising a multiplication of a price of the product minus a cost of the promotion and an acceptance probability, and the standard deviation of the rewards based on the confidence level of the logit model.

20. The computer readable storage medium of claim 15, further comprising constructing the logit model comprising a probability estimation function that takes the first set of features and the second set of features and generates an acceptance probability of the promotion, by determining the parameters of the logit model via logistic regression using data associated with observed responses to the promotion of users and snapshots of user features of the users and product features of one or more products for which the promotion was offered.
